(19) United States
(12) Patent Application Publication
(10) Pub. No.: US 2020/0150418 A1
(43) Pub. Date: May 14, 2020

(54) DISTANCE MEASUREMENT DEVICE AND MOBILE BODY

(71) Applicants: TAKUMI SATOH, MIYAGI (JP); TOSHIYUKI IKEOH, Düsseldorf (DE); TSUYOSHI UENO, KANAGAWA (JP); KAZUMA IZUMIYA, MIYAGI (JP)

(72) Inventors: TAKUMI SATOH, MIYAGI (JP); TOSHIYUKI IKEOH, Düsseldorf (DE); TSUYOSHI UENO, KANAGAWA (JP); KAZUMA IZUMIYA, MIYAGI (JP)

(73) Assignee: Ricoh Company, Ltd., Tokyo (JP)

(21) Appl. No.: 16/591,787

(22) Filed: Oct. 3, 2019

(30) Foreign Application Priority Data
Nov. 9, 2018 (JP) 2018-211767

(51) Int. Cl. G02B 26/08; G02B 26/10; G02B 26/12; G01S 17/10; G01S 7/481; G05D 1/02; G06T 7/521; G01S 17/89; G01S 17/02

(52) U.S. Cl. CPC G02B 26/0858; G02B 26/105; G02B 26/124; G01S 17/10; G01S 17/026; G05D 1/024; G06T 7/521; G01S 17/89; G01S 7/4817

(57) ABSTRACT

A distance measurement device configured to measure a distance to at least one object to be measured includes a light receiving element; a condenser optical system configured to focus light onto the light receiving element, and having field curvature aberration; and a variable deflector disposed in an optical path between the light receiving element and the condenser optical system. The light receiving element receives light deflected by the variable deflector.

### CROSS-REFERENCE TO RELATED APPLICATIONS

This patent application is based on and claims priority pursuant to 35 U.S.C. § 119(a) to Japanese Patent Application No. 2018-211767, filed on Nov. 9, 2018, in the Japan Patent Office, the entire disclosure of which is hereby incorporated by reference herein.

### BACKGROUND

### Technical Field

The present disclosure relates to a distance measurement device and a mobile body.

### Description of the Related Art

There is known a distance measurement device such as a light detection and ranging (LiDAR) device that is mounted on a mobile body such as a vehicle, and that recognizes a leading vehicle or an obstruction existing on a drive lane, or a lane marker such as a white line or a Catseye (registered trademark) representing a lane division. There is also known, for distance measurement in a wide range, a LiDAR device using a wide-angle condenser optical system such as a fish-eye lens.

### SUMMARY

A distance measurement device configured to measure a distance to at least one object to be measured according to one aspect of the present disclosure includes a light receiving element; a condenser optical system configured to focus light onto the light receiving element, and having field curvature aberration; and a variable deflector disposed in an optical path between the light receiving element and the condenser optical system. The light receiving element receives light deflected by the variable deflector.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram of an example of a configuration of a LiDAR device according to a first embodiment;

FIG. 2 is an enlarged view of an example of a configuration in the vicinity of an installation portion of a condenser lens and a light receiving element according to the first embodiment;

FIG. 3 is a view of the relation between field curvature aberration of the condenser lens and deflection by a movable mirror;

FIG. 4 is a view of an example of a configuration of the movable mirror according to the first embodiment;

FIGS. 5A to 5C are views each of an example of a configuration of the condenser lens according to the first embodiment, FIG. 5A illustrating focusing of incident light at an angle of view of −50 degrees, FIG. 5B illustrating focusing of incident light at an angle of view of 0 degrees, FIG. 5C illustrating focusing of incident light at an angle of view of +50 degrees; and

FIG. 6 is a view of an example of a configuration of a vehicle according to a second embodiment.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Embodiments of the present disclosure are described in detail with reference to the drawings. Like reference signs are applied to identical or corresponding components throughout the drawings and redundant description thereof may be omitted.

### First Embodiment

In a first embodiment, a light detection and ranging (LiDAR) device is described as an example of a distance measurement device.

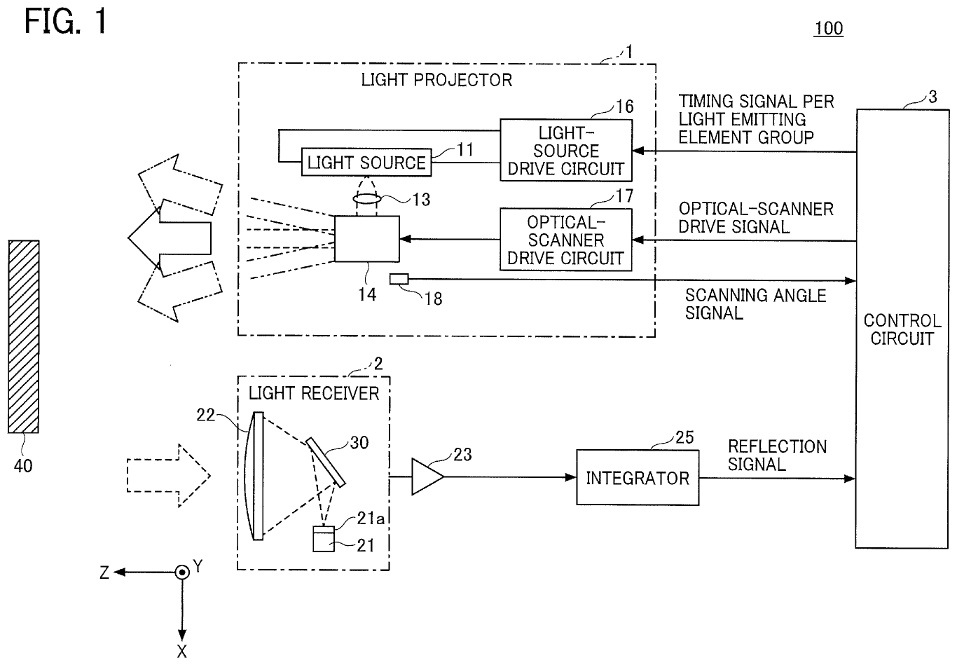

FIG. 1 is a diagram explaining an example of a configuration of a LiDAR device 100 according to the present embodiment. The LiDAR device 100 includes a light projector 1 that projects light from a light source, a light receiver 2 that receives the reflected light from an object 40, an integrator 25 that time-integrates an output signal from the light receiver 2, and a control circuit 3 that performs control on the light projector 1 and distance measurement based on a reflection signal. In FIG. 1, the output of the light receiver 2 is coupled to the input of the integrator 25, and the time-integrated reflection signal is input to the control circuit 3. Alternatively, the control circuit 3 may include the integrator 25.

In a LiDAR device mounted on a mobile body such as a vehicle, the light projector 1 and the light receiver 2 are typically disposed in a front section of the vehicle to detect an object existing at the front side of the vehicle. However, the LiDAR device may not be disposed in the front section, and may be installed at any position of the vehicle, for example, to detect an object at a lateral side or the rear side of the vehicle.

The light projector 1 includes a light source 11, a coupling lens 13, an optical scanner 14, a light-source drive circuit 16, an optical-scanner drive circuit 17, and a scanning-angle monitor 18.

The light source 11 includes a plurality of light emitting element groups separately disposed in an optical scanning direction. Each light emitting element group includes a plurality of vertical cavity surface emitting lasers (VCSELs). The light source 11 is coupled to the control circuit 3 via the light-source drive circuit 16, and is controlled by the control circuit 3 so that the light emitting element groups emit light at mutually independent light emitting timings.

The coupling lens 13 couples laser beams emitted from the light source 11 to the optical scanner 14. The optical scanner 14 performs scanning in an XZ plane by emitting the laser beams output from the plurality of light emitting element groups of the light source 11, to the same detection region. With the deflection of the laser beams given by the optical scanner 14, an object existing in a predetermined angular range is detected, and the distance to the detected object can be measured.

The scanning angle of the laser beams using the optical scanner 14 may be detected by the scanning-angle monitor 18 and fed to the control circuit 3. In this case, the monitor result is fed back to an optical-scanner drive signal to control the scanning angle and the scanning frequency.

The light receiver 2 includes a light receiving element 21, an optical filter 21a, and a condenser lens 22. The condenser lens 22 focuses the laser beams reflected from an object existing in the scanning direction with the laser beams, onto a light receiving surface of the light receiving element 21. The light receiving element 21 is, for example, a photodiode or an avalanche photodiode (APD). The condenser lens 22 is an example of “a condenser optical system”.

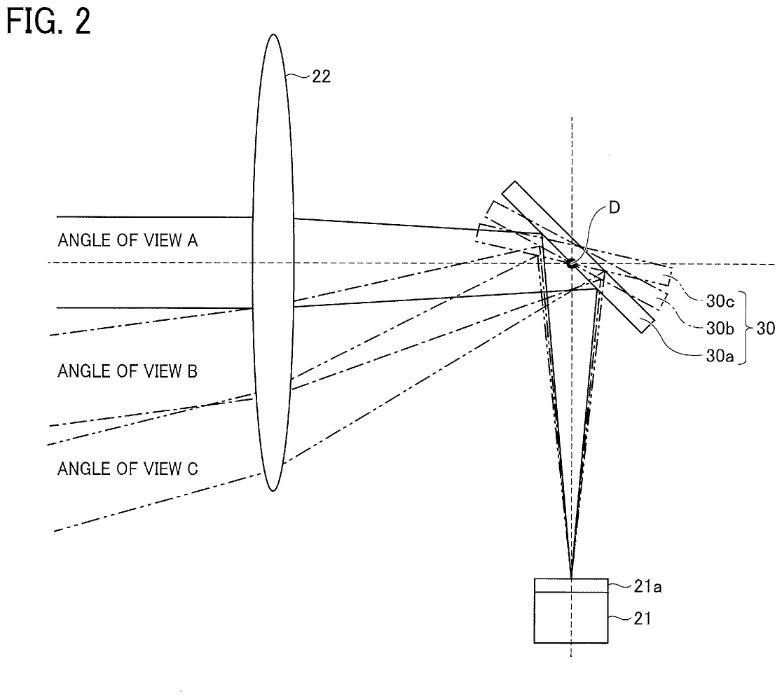

In the present embodiment, a movable mirror 30 is provided in the optical path between the condenser lens 22 and the light receiving element 21. The movable mirror 30 deflects the light focused by the condenser lens 22 in a manner that the angle of the light is variable. The details of the movable mirror 30 will be described later with reference to FIGS. 2 to 4.

The light projector 1 and the light receiver 2 are closely disposed, and the optical axes of the light projector 1 and the light receiver 2 seem to be coaxial to each other when viewed at a position several meters away therefrom. The light reflected from an object is scattered in various directions at the reflection point. A light component that returns along the optical path equivalent to the optical path of the laser beams output from the LiDAR device 100 is guided to the light receiving element 21 via the condenser lens 22, and is detected as a reflection signal.

The light receiving element 21 outputs a photocurrent corresponding to the intensity of input reflected light. The photocurrent is an example of “an electric signal”. The photocurrent output from the light deceiving element 21 is converted into a voltage signal by a transimpedance amplifier (not illustrated), is amplified by an amplifier 23, and then is input to the integrator 25. The integrator 25 integrates the detection signals of the light output from the plurality of light emitting element groups at different light emitting timings through single scanning and reflected by an object, and outputs the sum total value of the detection signals to the control circuit 3.

The optical filter 21a is a band-pass filter that is provided on the light receiving surface of the light receiving element 21 and that allows light within a predetermined frequency band (wavelengths) to pass therethrough. The optical filter 21a allows only light within a frequency band close to the frequency band of the laser beams emitted from the light source 11 to selectively pass therethrough. Thus, the optical filter 21a can block noise light included in the light incident on the optical filter 21a. The position of the optical filter 21a is not limited to a position on the light receiving surface of the light receiving element 21, and may be at any position in the optical path between the condenser lens 22 and the light receiving element 21.

The control circuit 3 measures the distance to the detected object based on the period from when a drive timing signal of a light source is output to when a detection signal is acquired, that is, based on the difference between the time at which the laser beams are emitted and the time at which the reflected light is received.

The control circuit 3 may be constituted of an integrated circuit chip, such as a large-scale integrated (LSI) chip or a microprocessor; a logic device such as a field programmable gate array (FPGA); or a combination of the integrated circuit chip and the logic device.

In the present embodiment, the quality of the laser beams output from each light emitting element group is ensured, and the angular resolution of the laser beams is maintained high. In addition, by irradiating the same detection area with a plurality of laser beams at different timings, the intensity in total is increased, and the measurable distance to an object can be increased. By integrating the detection signals based on the reflected light, the detection signals can be acquired with a high signal to noise (SN) ratio, and distance measurement with high accuracy can be performed.

With the distance measurement, a distance image including a detection region in an XZ plane is acquired in accordance with the scanning with the laser beams in the XZ plane by the light projector 1. The distance image includes all objects existing in the detection region in the XZ plane. Thus, distance information can be acquired from each pixel constituting the objects in the distance image.

The function of the movable mirror 30 disposed in the optical path between the condenser lens 22 and the light receiving element 21 is described next with reference to FIG. 2. In this case, the movable mirror 30 is an example of “a variable deflector”.

FIG. 2 is an enlarged view explaining an example of a configuration in the vicinity of an installation portion of the condenser lens 22 and the light receiving element 21.

The LiDAR device 100 according to the present embodiment includes the movable mirror 30 in the optical path between the condenser lens 22 and the light receiving element 21. The movable mirror 30 rotates around a rotation axis D and hence deflects the laser beams, which pass through the condenser lens 22 and are incident on the movable mirror 30, toward the light receiving element 21. The light deflected by the movable mirror 30 is focused onto the light receiving surface of the light receiving element 21.

FIG. 2 illustrates movable mirrors 30 in three states when the angle of rotation is changed to focus the laser beams incident on the movable mirror 30 onto the light receiving surface of the light receiving element 21 in correspondence with three angles of view of the laser beams incident on the condenser lens 22.

Specifically, a movable mirror 30a indicates a movable mirror in a state rotated to an angle at which the condenser lens 22 can focus the light incident on the condenser lens 22 at an angle of view A onto the light receiving surface of the light receiving element 21. A movable mirror 30b indicates a movable mirror in a state rotated to an angle at which the condenser lens 22 can focus the light incident on the condenser lens 22 at an angle of view B onto the light receiving surface of the light receiving element 21. A movable mirror 30c indicates a movable mirror in a state rotated to an angle at which the condenser lens 22 can focus the light incident on the condenser lens 22 at an angle of view C onto the light receiving surface of the light receiving element 21. The magnitudes of the angles of view A, B, and C have a relation of A<B<C.

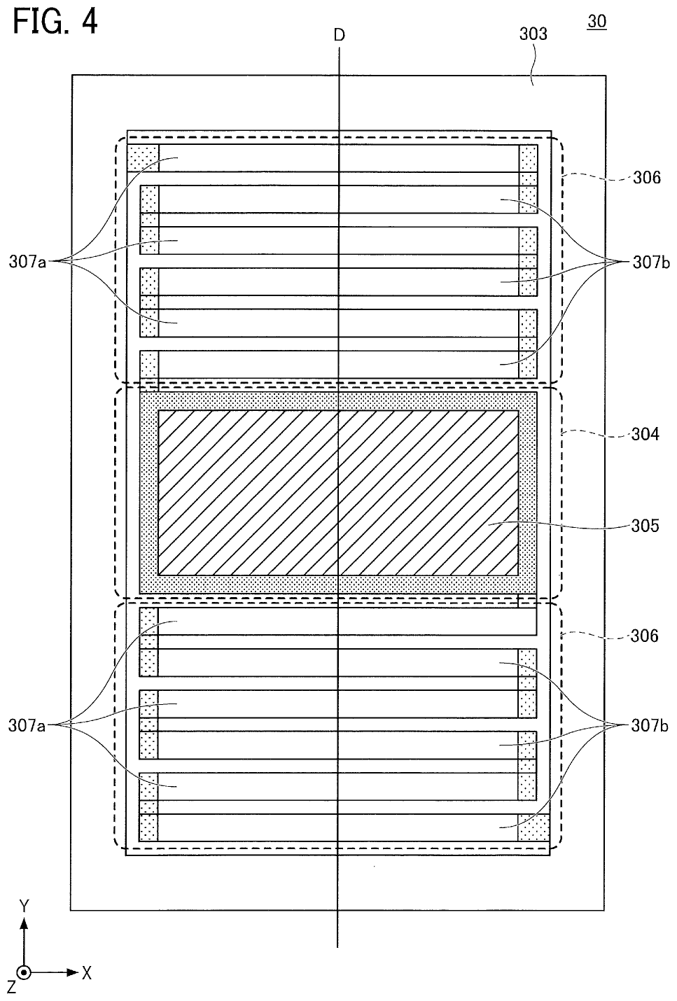

The movable mirror 30 is a micro-electromechanical system (MEMS) mirror configured such that a mirror including a reflection surface is integrally formed with an elastic beam. The details of the configuration will be described later with reference to FIG. 4. In this case, the movable mirror 30 is an example of “a movable reflector”.

“The variable deflector” is not limited to the movable mirror 30 as far as the variable deflector deflects the angle of incident light. A mirror or a prism may be driven by a piezoelectric actuator, or a polygon mirror, which is an example of “a rotational polygon mirror”, may be rotated by electromagnetic driving. Alternatively, an electrostatically-driven MEMS mirror or an acoustooptic element may be used.

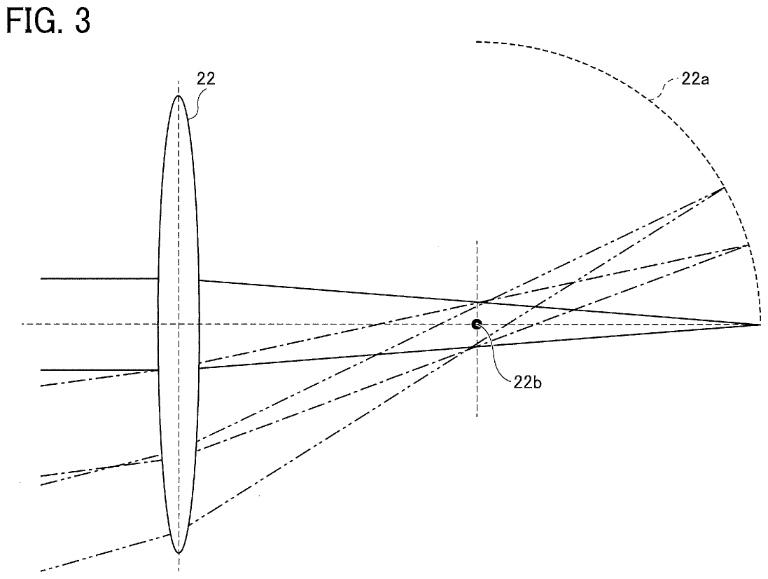

FIG. 3 is a view explaining the relation between field curvature by the condenser lens 22 and deflection by the movable mirror 30.

Field curvature represents a phenomenon in which, when an image of a planar object is formed by an optical system, a planar image is not obtained but a curved image is obtained in a focal plane. Field curvature aberration represents optical aberration caused by the field curvature. In an image forming optical system having large field curvature, the focused point of a center portion (a portion with a small angle of view) of an obtained image is deviated from the focused point of a peripheral portion (a portion with a large angle of view) in the optical-axis direction. Thus, when one of the center portion and the peripheral portion is in focus, the other is out of focus. The focused spot diameter in the out-of-focus state may be larger than the focused spot diameter in the in-focus state.

A condenser optical system is typically designed to correct field curvature aberration; however, a wide-angle image forming optical system has a limitation on the correction, and may not sufficiently correct field curvature aberration. In this case, the focused spot diameter of light incident on a light receiving surface of a light receiving element at a wide angle of view increases due to defocus caused by the field curvature aberration of the condenser optical system. To receive the focused spot with the increased diameter, a light receiving element having a large light receiving surface is required. Such a light receiving element having a large light receiving surface has a low signal to noise (SN) ratio. This may lead to improper measurement of the distance to an object.

Owing to this, in the present embodiment, as illustrated in FIG. 3, the field curvature aberration of the condenser lens 22 is controlled so that the focused point at each angle of view of the laser beams incident on the condenser lens 22 is on an arc 22a centered at the position of the movable mirror 30. That is, when a group of focused points that vary in accordance with the incident angle serves as a focused surface, the condenser lens 22 is designed so that the focused surface is under-corrected (under-correction). By disposing the light receiving surface of the light receiving element 21 at a predetermined position on the arc 22a, the laser beams are deflected by the movable mirror 30 and focused. In this case, “under-correction” represents field curvature that is more inclined from the focused surface toward the object side (the condensed optical system side) as the distance from the optical axis increases (toward the wide angle side).

In other words, by rotating the movable mirror 30 around, as a rotation axis, an axis including a curvature center 22b of the field curvature, the laser beams are deflected toward the light receiving surface of the light receiving element 21 and focused at the light receiving surface while the curvature center of the field curvature by the condenser lens 22 serves as a deflection position.

Thus, the distance by which the laser beams at each angle of view are focused can be equal to the distance from the movable mirror 30 to the light receiving element 21 in the path between the deflection position by the movable mirror 30 to the light receiving surface of the light receiving element 21, thereby providing an effect equivalent to the effect provided when laser beams are focused at light receiving surfaces of light receiving elements 21 disposed at a plurality of positions corresponding to angles of view on the arc 22a.

The laser beams incident on the condenser lens 22 at each angle of view can be focused onto the light receiving surface of the light receiving element 21 with a predetermined spot diameter without generation of defocus due to field curvature aberration.

As described above, a light receiving sensor is planar in many cases. The field curvature aberration is desirably corrected and the focused surface is desirably planar. In the present embodiment, however, the field curvature aberration is controlled so that the focused surface is positioned on the arc centered at the position of the movable mirror. Thus, the optical path after reflection by the movable mirror is equivalent also for light with a large incident angle. The size of the light receiving sensor can be decreased.

Although the focused surface is theoretically desirably on the arc centered at the position of the movable mirror, the influence of the field curvature aberration actually tends to increase as light is incident at a wider angle. It is difficult to position the focused surface on the arc. As compared with a case where the focused surface is planar, however, the focused spot diameter of light incident at a wide angle can be also decreased, thereby decreasing the size of the light receiving sensor.

In the present embodiment, since the focused spot diameter is not increased due to defocus on the light receiving surface of the light receiving element 21 also for laser beams incident on the condenser lens 22 at a large angle of view, a light receiving element having a large light receiving surface is not required. Thus, the distance measurement device such as a LiDAR device using a wide-angle condenser optical system can properly measure a distance without a decrease in SN ratio.

FIG. 4 is a view explaining an example of a configuration of the movable mirror 30 according to the present embodiment.

As described above, the movable mirror 30 is a MEMS mirror configured such that a reflector including a reflection surface is integrally formed with an elastic beam.

The movable mirror 30 includes a movable portion 304 including a reflection surface 305, and a pair of meandering beams 306 that support the movable portion 304 at both sides of the movable portion 304. One end of each meandering beam 306 is fixed to a support substrate 303 and the other end thereof is coupled to the movable portion 304.

Each meandering beam 306 includes a first piezoelectric member 307a and a second piezoelectric member 307b disposed alternately to each other, and forms a meandering pattern via a plurality of folded portions. Voltage signals in mutually opposite phases are respectively applied to the first piezoelectric member 307a and the second piezoelectric member 307b that are disposed next to each other, and the meandering beam 306 is warped in the Z direction.

The first piezoelectric member 307a and the second piezoelectric member 307b that are disposed next to each other are warped in opposite directions. The warps in the opposite directions are accumulated, and hence the movable portion 304 including the reflection surface 305 rotates in a reciprocating manner around the rotation axis D.

By applying opposite-phase sine waves having a driving frequency corresponding to a mirror resonant mode around the rotation axis D respectively to the first piezoelectric member 307a and the second piezoelectric member 307b, a large rotational angle can be obtained with a low voltage.

The movable mirror 30 performs optical scanning in one-axis direction (X direction). For detection and measurement in the perpendicular direction (Y direction), the number of layers can be increased by switching emission of the plurality of light emitting element groups separately disposed in the Y direction.

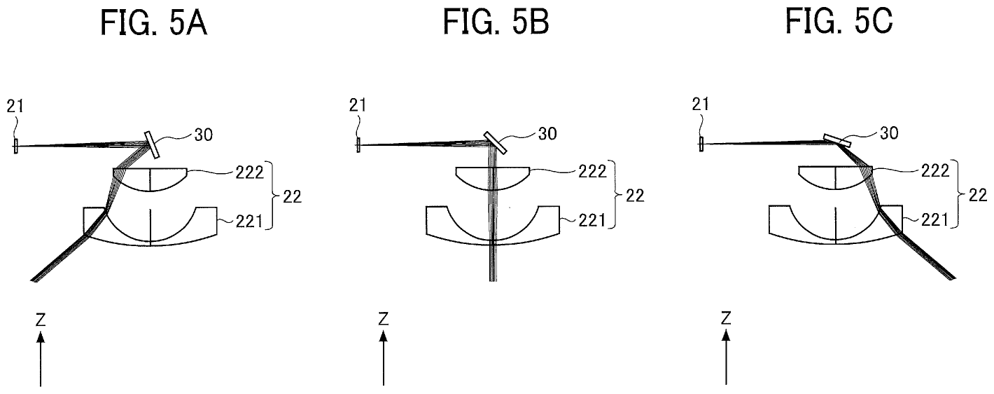

A configuration of the condenser lens 22 is described next. FIGS. 5A to 5C each are a view explaining an example of a configuration of the condenser lens 22 according to the present embodiment. FIG. 5A illustrates image formation of incident light at an angle of view of −50 degrees, FIG. 5B illustrates image formation of incident light at an angle of view of 0 degrees, and FIG. 5C illustrates image formation of incident light at an angle of view of +50 degrees. The Z direction indicates a direction along the optical axis of the condenser lens 22.

In FIGS. 5A to 5C, the condenser lens 22 includes a first lens 221 and a second lens 222 each having a first surface at the object side and a second surface at the image side. The first lens 221 is a negative meniscus lens having a curvature radius of 87.356 mm at the first surface and a curvature radius of 18.88 mm at the second surface. The first lens 221 has a thickness of 1.6 mm and a refractive index of 1.517. The second lens 222 is a positive meniscus lens having a curvature radius of 17.665 mm at the first surface and a curvature radius of 690.466 mm at the second surface. The second lens 222 has a thickness of 8.582 mm and a refractive index of 1.517. The distance between the first lens 221 and the second lens 222 is 19.751 mm, the distance between the second lens 222 and the movable mirror 30 is 9.179 mm, and the distance between the movable mirror 30 and the light receiving surface 21 is 53.198 mm. The numerical values listed above are examples of design values, and other design values may be used.

FIGS. 5A to 5C each illustrate, at each angle of view, a state in which laser beams with a beam diameter of 3 mm are incident on the condenser lens 22, pass through the condenser lens 22, then are deflected by the movable mirror 30 with a diameter of 10 mm toward the light receiving element 21, and are focused within the light receiving surface with a diameter of 0.6 mm of the light receiving element 21.

The condenser lens 22 includes two lenses of the first lens 221 having a negative refractive power and the second lens 222 having a positive refractive power.

The distance from a surface of the first lens 221 at the negative Z-direction side to the movable mirror 30 is 40 mm. The distance from the movable mirror 30 to the light receiving element 21 is 70 mm. The first lens 221 has a diameter of 55 mm. The second lens 222 has a diameter of 27 mm.

FIG. 5A illustrates a state in which the incident light at the angle of view of −50 degrees is deflected by the movable mirror 30 that is rotated to an angle of 22 degrees with respect to the Z direction, and the deflected light is focused onto the light receiving surface of the light receiving element 21.

FIG. 5B illustrates a state in which the incident light at the angle of view of 0 degrees is deflected by the movable mirror 30 that is rotated to an angle of 45 degrees with respect to the Z direction, and the deflected light is focused onto the light receiving surface of the light receiving element 21.

FIG. 5C illustrates a state in which the incident light at the angle of view of +50 degrees is deflected by the movable mirror 30 that is rotated to an angle of 67 degrees with respect to the Z direction, and the deflected light is focused onto the light receiving surface of the light receiving element 21.

In the present embodiment, since the field curvature aberration is controlled and actively used as described above, the condenser lens 22 may have large field curvature aberration. The limitation of the field curvature aberration in optical design is relaxed, and a simple lens configuration such as two lenses including a lens having a negative refractive power and a lens having a positive refractive power can provide a wide-angle image forming optical system.

The example in which the condenser lens 22 uses the two lenses is described above; however, the condenser lens 22 may use one lens.

Moreover, the numerical values, such as the diameter of the light receiving surface of the light receiving element 21 and the diameter of the movable mirror 30, are examples, and are not limited.

As described above with reference to FIG. 1, the light projector 1 according to the present embodiment employs a one-axis scanning system that performs scanning in the X direction using the optical scanner 14 by emitting the laser beams output from the light source 11 to a predetermined detection region, and that uses divergence of the laser beams from the light source in the Z direction. The laser beams used for scanning in this way are an example of “scanning light”.

Alternatively, as a light projection system other than the above, a two-axis scanning system that performs scanning in an XZ plane using the optical scanner 14 with laser beams from a light source, or a flash system that collectively projects expanded beams such as laser beams may be employed.

Moreover, the light receiver 2 may employ one of two systems including a one-axis rotation system of rotating the movable mirror 30 around one axis, and a two-axis rotation system of rotating the movable mirror 30 around two axes intersecting with each other. One of the axes in the two-axis rotation system is an example of “a first axis”, and the movable mirror that rotates around the first axis is an example of “a first movable reflector”. The other one of the axes is an example of “a second axis”, and the movable mirror that rotates around the second axis is an example of “a second movable reflector”.

Thus, the light projector 1 of one of the various systems and the light receiver 2 of one of the various systems may be combined. The operation of each combination is described below.

1. Case where Light Projector 1 Employs One-Axis Scanning System and Light Receiver 2 Employs One-Axis Rotation System

The light projector 1 performs one-axis scanning using the optical scanner 14 with laser beams emitted from a semiconductor laser. Synchronous control is performed on the rotation of the movable mirror 30 in correspondence with the angle of view at which the reflected light from an object of the laser beams of scanning is incident on the condenser lens 22 of the light receiver 2.

Thus, the movable mirror 30 can deflect the light to be focused at an angle corresponding to the angle of view of the incident light on the condenser lens 22, and can cause the light to be focused onto the light receiving surface of the light receiving element 21.

The light projector 1 does not cause light to perform scanning in the direction perpendicular to the scanning direction of the optical scanner 14. However, by expanding the laser beams in the perpendicular direction, the light projector 1 can project the laser beams also in the perpendicular direction. In this case, a distance detection region in an XZ plane is determined in the direction perpendicular to the scanning direction of the light projector 1, in accordance with the allowable angle of view of the condenser lens 22.

### 2. Case Where Light Projector 1 Employs Flash System and Light Receiver 2 Employs One-Axis Rotation System

With the flash system, the light projector 1 irradiates an object with laser beams emitted from a semiconductor laser by expanding the laser beams using a diffusion optical system or an expansion optical system. The light projector 1 using the flash system is an example of “a light projector configured to simultaneously project light”.

By receiving the reflected light from all objects existing in a detection region in an XZ plane, the light receiver 2 can simultaneously measure the distances to the objects.

In this case, the acquisition speed of a distance image is determined by the rotation speed of the movable mirror 30. When a resonance mirror is used as the movable mirror 30, the acquisition speed of a distance image is determined in accordance with the resonance frequency.

For the light incident on the condenser lens 22 at an angle of view in the direction perpendicular to the rotation direction of the movable mirror 30, a distance detection region is determined in accordance with the allowable angle of view of the condenser lens 22.

3. Case where Light Projector 1 Employs One-Axis Scanning System and Light Receiver 2 Employs Two-Axis Rotation System

The light projector 1 performs one-axis scanning using the optical scanner 14 with laser beams emitted from a semiconductor laser. Synchronous control is performed on the rotation of each of two movable mirrors 30 in correspondence with the angle of view at which the reflected light from an object of the laser beams of scanning is incident on the condenser lens 22 of the light receiver 2.

Like the above-described case 1, the light projector 1 does not cause light to perform scanning in the direction perpendicular to the scanning direction of the optical scanner 14. However, by expanding the laser beams in the perpendicular direction, the light projector 1 can project the laser beams also in the perpendicular direction. Also in this case, a distance detection region is determined in the direction perpendicular to the scanning direction of the light projector 1, in accordance with the allowable angle of view of the condenser lens 22.

4. Case where Light Projector 1 Employs Two-Axis Scanning System and Light Receiver 2 Employs Two-Axis Rotation System

The light projector 1 performs two-axis scanning using the two-axis optical scanner 14 with laser beams emitted from a semiconductor laser. Synchronous control is performed on the rotation of the two movable mirrors 30 in correspondence with the angle of view at which the reflected light from an object of the laser beams of scanning is incident on the condenser lens 22 of the light receiver 2.

Since the light projector 1 performs two-axis scanning, the angle of divergence of the laser beams for irradiation on an object can be restricted, and the quantity of irradiation light on an object and the quantity of the reflected light from the object can be increased. Thus, distance measurement accuracy can be increased.

5. Case where Light Projector 1 Employs Flash System and Light Receiver 2 Employs Two-Axis Rotation System

The light projector 1 irradiates a detection object with laser beams emitted from a semiconductor laser by expanding the laser beams using a diffusion optical system or an expansion optical system. The acquisition speed of a distance image is determined in accordance with the scanning speed of the movable mirror 30 of the light receiver 2 like the above-described case 3.

Described next is comparison between a coaxial LiDAR device according to a comparative example and a LiDAR device according to the present embodiment. The coaxial LiDAR device is a LiDAR device in which the optical axis of a projection optical system included in a light projector is aligned with the optical axis of a condenser optical system included in a light receiver.

In a LiDAR device, to increase a measurable distance, the quantity of the reflected light from an object is desirably large. However, when the LiDAR device according to the present embodiment is constituted of a coaxial LiDAR device, the laser beams of scanning using the optical scanner 14 of the light projector 1 have to pass through the condenser lens 22, and hence the angle of divergence of the laser beams increases. Thus, the quantity of irradiation light on an object is decreased, the SN ratio of the reflected light from the object is decreased, and the distance measurement accuracy is decreased.

Owing to this, according to the present embodiment, the condenser lens 22 and the light projector 1 are disposed at different positions in a plane intersecting with the optical axis of the condenser lens 22.

The laser beams of scanning using the optical scanner 14 of the light projector 1 do not pass through the condenser lens 22, and hence the angle of divergence can be restricted. Thus, the quantity of irradiation light on an object is ensured, the SN ratio of the reflected light from the object is increased, and the distance can be properly measured.

As described above, in the present embodiment, by using the movable mirror 30 disposed in the optical path between the condenser lens 22 and the light receiving element 21, a light receiving element with a large light receiving surface is not required. Thus, the distance measurement device such as a LiDAR device using a wide-angle condenser optical system can properly measure a distance without a decrease in SN ratio.

Furthermore, a typical wide-angle lens is an optical system including four to five lenses, whereas the number of lenses is one to two according to the present embodiment and the loss due to reflection at a lens is decreased. Thus, light utilization efficiency can be increased.

### Second Embodiment

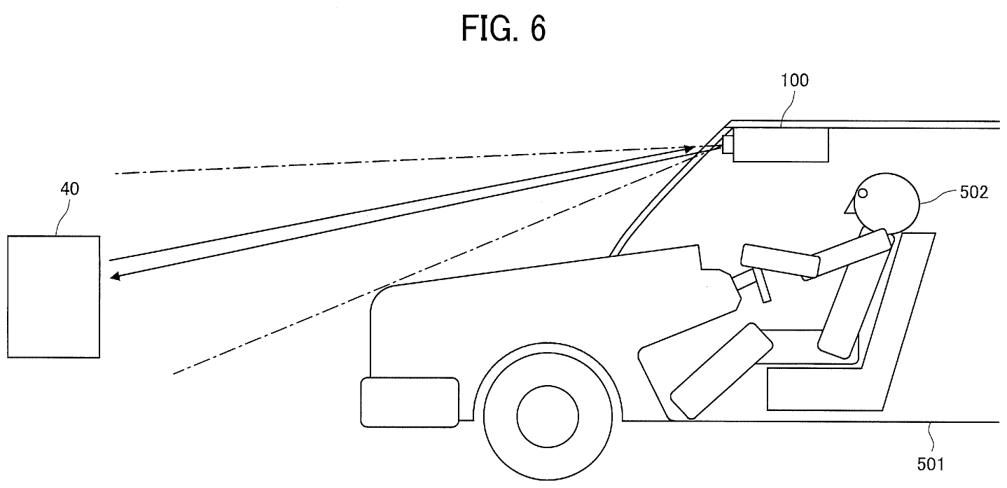

A mobile body according to a second embodiment is described next with reference to FIG. 6. Like reference signs are applied to components identical or corresponding to those of the first embodiment as described above, and redundant description thereof is omitted.

FIG. 6 is a view explaining an example of a configuration of a vehicle 501 according to the present embodiment. The LiDAR device 100 is mounted on the vehicle 501. In this case, the vehicle 501 is an example of “a mobile body”.

The LiDAR device 100 is attached to an upper portion of a windshield or a ceiling portion above a front seat of the vehicle 501. The LiDAR device 100 recognizes an object 40 existing in a travel direction of the vehicle 501 by performing optical scanning in the travel direction and receiving the reflected light from the object 40, and measures the distance to the object 40. The recognized object 40 is displayed on a display device or the like. Thus, a driver 502 can visually recognize the object 40.

The light projector 1 of the LiDAR device 100 performs optical scanning while restricting the angle of divergence of the laser beams in advance by using an optical element such as a microlens array (MLA). Thus, the optical loss by a scanner such as the optical scanner 14 is decreased, and laser beams can be projected to a distant place with high angular resolution.

The mount position of the LiDAR device 100 is not limited to an upper and front portion of the vehicle 501, and the LiDAR device 100 may be mounted at a side surface or a rear portion of the vehicle 501. The LiDAR device 100 is applicable to, without limited to a vehicle, any mobile body, for example, a flying body, such as an aircraft or a drone; or an autonomous mobile body such as a robot. By employing the configuration of the light projector 1 according to the present embodiment, the existence of an object and the position of the object can be detected in a wide range.

Although the embodiments of the present disclosure are described above, the present disclosure is not limited to such specific embodiments, and the embodiments may be modified and changed in various ways without departing from the spirit and scope of the present disclosure as set forth in the appended claims.

In the embodiments, the LiDAR device 100 is described as an example of the distance measurement device. However, no limitation is intended thereby. The distance measurement device may be any device that performs distance measurement by projecting light on an object and receiving the reflected light from the object.

For example, the present disclosure is also applicable to a biometric authentication apparatus, a security sensor, or a component of a three-dimensional scanner, for example. The biometric authentication apparatus performs optical scanning on a hand or face to obtain distance information, calculates object information such as the shape of the object based on the distance information, and refers to records to recognize the object. The security sensor performs optical scanning in a target range to recognize an incoming object. The three-dimensional scanner performs optical scanning to obtain distance information, calculates object information such as the shape of the object based on the distance information to recognize the object, and outputs the object information in the form of three-dimensional data.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A distance measurement device configured to measure a distance to at least one object to be measured, the distance measurement device comprising:
a light receiving element;
a condenser optical system configured to focus light onto the light receiving element, and having field curvature aberration; and
a variable deflector disposed in an optical path between the light receiving element and the condenser optical system,
wherein the light receiving element receives light deflected by the variable deflector.

2. The distance measurement device according to claim 1,
wherein the field curvature aberration is under-correction.

3. The distance measurement device according to claim 1,
wherein the variable deflector deflects the focused light in a manner that an angle of the focused light is variable, at a curvature center of field curvature by the condenser optical system.

4. The distance measurement device according to claim 1,
wherein the variable deflector includes a movable reflector including a reflection surface configured to be rotatable.

5. The distance measurement device according to claim 4,
wherein the light receiving element includes a light receiving surface, and is disposed in a direction orthogonal to an optical axis of the condenser optical system so that the light receiving surface is parallel to the optical axis, and
wherein the variable deflector rotates the reflection surface around, as a rotation axis, an axis including a point at which an axis orthogonal to a surface center of the light receiving surface intersects with the optical axis of the condenser optical system.

6. The distance measurement device according to claim 4,
wherein the reflection surface is a surface included in a prism.

7. The distance measurement device according to claim 4,
wherein the movable reflector includes
a first movable reflector having a first axis as a rotation axis of the reflection surface, and
a second movable reflector having a second axis as a rotation axis of the reflection surface, the second axis differing from the first axis.

8. The distance measurement device according to claim 4,
wherein the variable deflector deflects the focused light by rotation of the reflection surface around, as a rotation axis, an axis including a curvature center of field curvature by the condenser optical system.

9. The distance measurement device according to claim 1,
wherein the variable deflector is a rotational polygon mirror configured to rotate a polyhedron including a plurality of reflection surfaces.

10. The distance measurement device according to claim 1,
wherein the variable deflector is an acoustooptic element.

11. The distance measurement device according to claim 1, further comprising a light projector configured to simultaneously project light to the at least one object in a detection region.

12. The distance measurement device according to claim 11,
wherein the condenser optical system and the light projector are disposed at different positions in a plane intersecting with an optical axis of the condenser optical system.

13. The distance measurement device according to claim 1, further comprising a light projector configured to perform scanning in two directions intersecting with each other in a plane intersecting with an optical axis of the condenser optical system, with light from a light source, and project scanning light to the at least one object in a detection region.

14. The distance measurement device according to claim 1,
wherein the condenser optical system includes two lenses of a lens having a negative refractive power and a lens having a positive refractive power.

15. A mobile body comprising the distance measurement device according to claim 1.
